(19) United States
(12) Patent Application Publication
(10) Pub. No.: US 2025/0267388 A1
(43) Pub. Date: Aug. 21, 2025

(54) Systems and Methods for Underwater Coaching Systems Using Wireless Audio Signals

(71) Applicant: Swimmersive Co., Hermosa Beach, CA (US)

(72) Inventors: Timothy Milam, Van Lear, KY (US); William Franklin Dunn, Jr., Austin, TX (US)

(73) Assignee: Swimmersive Co., Hermosa Beach, CA (US)

(21) Appl. No.: 19/059,048

(22) Filed: Feb. 20, 2025

Related U.S. Application Data
(60) Provisional application No. 63/555,686, filed on Feb. 20, 2024.

(51) Int. Cl. H04R 1/10; H01Q 1/36; H04R 1/06

(52) U.S. Cl. CPC H04R 1/1016; H01Q 1/362; H04R 1/06; H04R 2420/07; H04R 2460/13

(57) ABSTRACT

Wireless audio receiver devices are described. In an embodiment, a wireless audio receiver device includes a first helical (helix wound) receive antenna and a second helical receive antenna, a printed circuit board (PCB) comprising receiver circuitry coupled to the first helical receive antenna and the second helical receive antenna, a first audio driver and a second audio driver, a first audio lead wire connected to the PCB and to the first audio driver and passing through the windings of the first helical antenna, and a second audio lead wire connected to the PCB and to the second audio driver and passing through the windings of the second helical antenna.

### CROSS-REFERENCE TO RELATED APPLICATION

The current application claims priority under 35 U.S.C. 119 (e) to U.S. Provisional Patent Application Ser. No. 63/555,686, entitled “Systems and Methods for Underwater Coaching Systems Using Wireless Audio Signals”, filed Feb. 20, 2024. The disclosure of U.S. Provisional Patent Application Ser. No. 63/555,686 is hereby incorporated by reference in its entirety.

### FIELD OF THE INVENTION

The present invention relates to circuitry for wirelessly transmitting audio and more specifically to antenna systems for water-based reception of an audio stream from an air-based transmitter.

### BACKGROUND

Radio frequency (RF) communication is the use of radio waves to transmit data wirelessly between a transmitter and a receiver.

### SUMMARY OF THE INVENTION

Systems and methods for wireless audio receiver devices are described. In an embodiment, a wireless audio receiver device includes a first helical (helix wound) receive antenna and a second helical receive antenna, a printed circuit board (PCB) comprising receiver circuitry coupled to the first helical receive antenna and the second helical receive antenna, a first audio driver and a second audio driver, a first audio lead wire connected to the PCB and to the first audio driver and passing through the windings of the first helical antenna, and a second audio lead wire connected to the PCB and to the second audio driver and passing through the windings of the second helical antenna.

In another embodiment, the first helical antenna and the second helical antenna are attached to and on opposing sides of the PCB.

In a further embodiment, the first helical antenna and the second helical antenna are each tapered in diameter of the helix.

In yet another embodiment, the helix of the antenna is tapered where the coil at its base is 10 mm outer diameter and the coil at its opposite end is 6 mm outer diameter.

In a still further embodiment, the first helical antenna and the second helical antenna coils are uniform 8 mm diameter.

Another embodiment includes a battery attached to the PCB.

Another embodiment again includes insulating material between the first audio lead wire and the first helical antenna and between the second audio lead wire and the second helical antenna.

In another embodiment, the insulating material is a dielectric tube.

In a further embodiment, the insulating material is a foam tube.

In yet another embodiment, the first audio lead wire is positioned within 80% cross sectional area of the helix of the first helical antenna, and the second audio lead wire is positioned within 80% cross sectional area of the helix of the second helical antenna.

In a still further embodiment, the first audio driver and the second audio driver are bone conductor speakers.

In another embodiment again, the bone conductor speakers have an F0 of 300 Hz.

In yet another further embodiment, the PCB contains an audio processor configured to extract an audio signal within a wireless signal received by the first helical antenna and the second helical antenna.

Other objects, advantages and novel features, and further scope of applicability of the present invention will be set forth in part in the detailed description to follow, and in part will become apparent to those skilled in the art upon examination of the following, or may be learned by practice of the invention. The objects and advantages of the invention may be realized and attained by means of the instrumentalities and combinations particularly pointed out in the detailed description and/or appended claims.

### BRIEF DESCRIPTION OF THE DRAWINGS

The description will be more fully understood with reference to the following figures, which are presented as exemplary embodiments of the invention and should not be construed as a complete recitation of the scope of the invention, wherein:

FIG. 1 conceptually illustrates an underwater coaching system in accordance with an embodiment of the invention;

FIG. 2 conceptually illustrates components of a wireless transmitter in accordance with an embodiment of the invention;

FIG. 3 conceptually illustrates components of a wireless receiver in accordance with an embodiment of the invention;

FIG. 4 illustrates components of a wireless receiver in accordance with an embodiment of the invention;

FIG. 5 illustrates dimensions of a helical receive antenna in accordance with an embodiment of the invention;

FIG. 6 illustrates a helical receive antenna in accordance with an embodiment of the invention;

FIG. 7 illustrates components of a wireless receiver in accordance with an embodiment of the invention.

### DETAILED DESCRIPTION

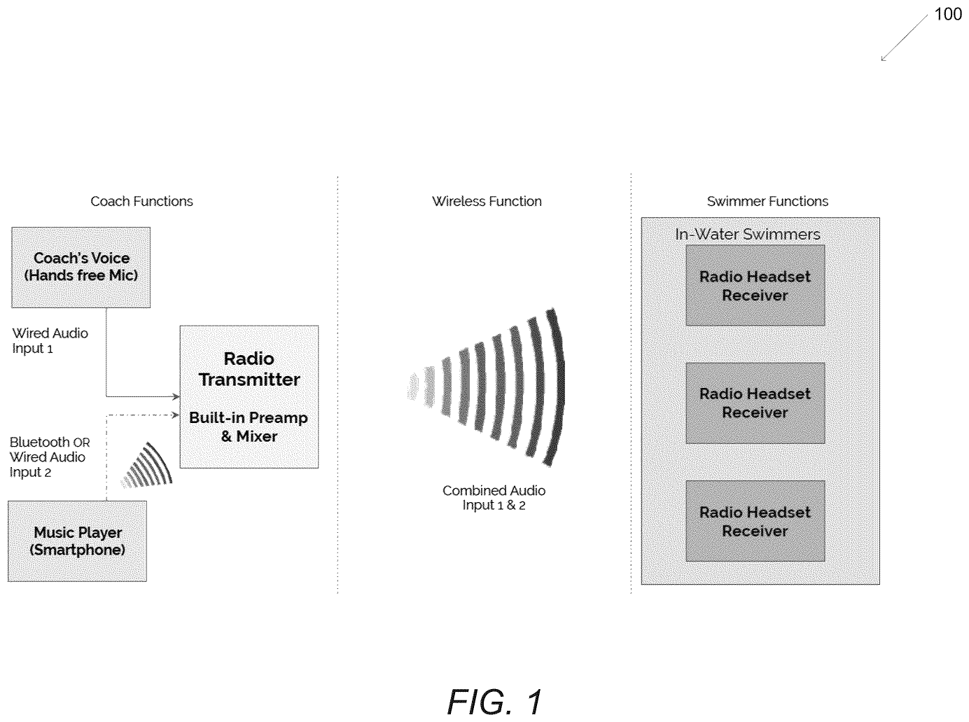

Turning now to the drawings, systems and methods for underwater coaching systems in accordance with embodiments of the invention are disclosed. Many people participate in water-based activities, such as swimming, rowing, sailing, and aerobics. Existing techniques for coaching participants in water-based activities include yelling at the participants from a distance and post-activity debriefing, as it can be difficult or impossible for instructors or coaches to interact directly with the participants while they are in the water. Underwater coaching systems in accordance with embodiments of the invention overcome these limitations and allow coaches and instructors to communicate directly with the participants, even when the participants are underwater and/or are a significant distance away from the coach or instructor. Conventional wireless communications systems are often unusable underwater or from air to water because the signals are severely attenuated in water. Wireless receiver systems in accordance with many embodiments of the invention provide the ability to receive a wireless signal through a substantial distance in water by using an optimized antenna design with the receiver circuitry. In FIG. 1, a conceptual illustration of an underwater coaching system 100 in accordance with an embodiment of the invention is shown. A coach's voice can be captured by a microphone as audio input 12 and optionally supplemental audio (e.g., Bluetooth or wired) can be provided as audio input 2. Audio inputs 1 and 2 can be combined and transmitted wirelessly to one or more radio headset receivers, which can be worn by swimmers. Wireless transmitters and receivers that may be utilized in accordance with embodiments of the invention are described more fully below. While the discussed systems and methods are described with respect to air to water transmissions, they may also be applied to air to air transmissions.

### Wireless Transmitters

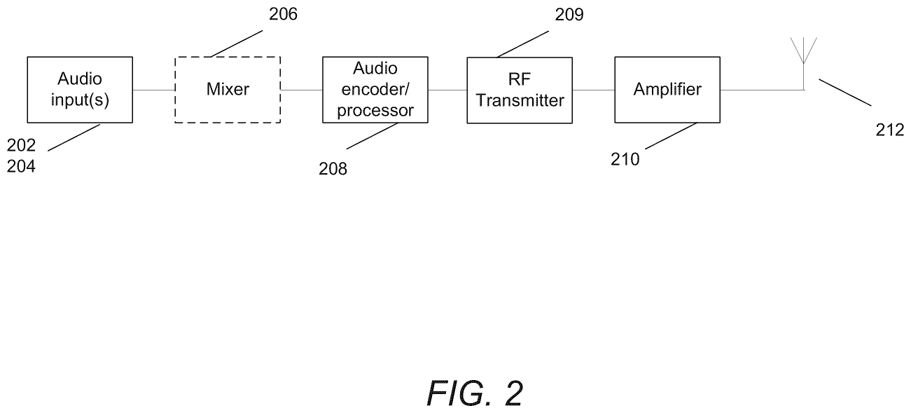

Underwater coaching systems in accordance with embodiments of the invention can include one or more transmitters, one or more receivers/headsets, and/or a case. The coaching system transmitter can be used to transmit audio data to one or more headset(s) that are worn by the participant(s). A wireless transmitter 200 that may be utilized in accordance with an embodiment of the invention is conceptually illustrated in FIG. 2. Components of the transmitter 200 can include one or more audio inputs 202 and 204 (e.g., microphone and optionally supplemental audio), mixer 206 to combine or switch between audio inputs 202 and 204, audio encoder/processor circuitry 208, radio frequency (RF) transmitter 209, amplifier 210 to amplify the signal for transmission, antenna 212. Several embodiments also include a battery (e.g., lithium polymer or other appropriate power source).

The transmitter 200 is capable of receiving input from one or more audio sources at audio inputs 202 and/or 204, such as but not limited to a microphone and/or a portable audio device. The audio sources can be connected directly and/or wirelessly, such as via a Bluetooth connection, as appropriate to the requirements of specific applications of embodiments of the invention. The audio inputs are not necessarily external to a device and can be onboard a device. In some embodiments, audio can be provided by applications on a smart device (e.g., smartphone). For example, audio may be provided by teleconference, chat, streaming media (video or audio), or other types of applications.

In a variety of embodiments, the transmitter 200 includes a variety of controllable input devices, such as a push-to-talk input that controls the transmission of voice data captured using a microphone, a play/pause input that controls the inclusion of audio from an audio device, volume controls, and/or any other input as appropriate to the requirements of specific applications of embodiments of the invention. The transmitter can combine the audio data received from the audio source(s) using a mixer 206. The audio data from the one or more sources can be processed (e.g., balancing and/or equalizing) and encoded using audio encoder/processor 208 into a single transmission signal using RF transmitter 209. Some embodiments utilize an analog audio encoder/processor, while other embodiments utilize a digital audio encoder/processor. The transmitter 200 can amplify the transmission signal using amplifier 210 and transmit the signal to the headsets using antenna 212.

The transmission of the audio to the headsets can be based on a pairing of headsets to the transmitter and/or a general broadcast at a particular frequency (or set of frequencies). For a general broadcast, any headset tuned to the appropriate frequency (or set of frequencies) may be able to receive the transmitted signal. The frequencies and modes of communication can be pre-determined and/or dynamically adjustable, thereby allowing the transmitter to communicate with devices over distances appropriate to the activity. For example, sailboats may be hundreds of yards apart while a coach working with swimmers will likely be within 50 yards of the swimmers. This adjustable frequency and power can also be used to improve the power efficiency of the system, allowing for longer battery life in lower-power modes at the cost of reduced transmission distance.

In many embodiments of the invention, the transmitter uses a 200 KHz channel in a band between 174-216 MHZ (CFR § 15.236). The transmitter can use one of several channels allocated across the band and may transmit at the maximum power allowed in the band of 50 mW EIRP. In several embodiments, the transmitter uses a band defined by EN 300 422. In some embodiments, the transmitter checks for a quiet channel (e.g., one that is relatively noise free and/or not used by other undesired devices) before use. It can do this by listening to several channels in the band and choosing one of the quietest channels. In several embodiments, status feedback to the user can be provided by an LED, such as a green LED, that can blink during the searching phase and turn solid to indicate the transmitter has selected a channel to use.

In several embodiments, the transmit frequency is selected based on one or more of the following criteria:
Loss in water (typically lower is better).
Loss at water/air interface (typically lower is better).
Antenna size (typically larger is better).
Regulatory band available.
ICs available to fit industrial design requirements (not all frequencies are available)

Any of a variety of transmitter circuitry may be utilized in a transmitter in accordance with embodiments of the invention. These components may be utilized to implement switching between analog sources (internal microphone, external microphone, wired audio, and Bluetooth audio), high level Bluetooth stack, and/or audio processing including adjustment of frequency response, and user interface functions.

In several embodiments, the transmitter utilizes a short coil antenna for transmission. For certain frequencies, such as those discussed further above, an ideal antenna would be an approximately 75 cm straight wire dipole or an approximately 37.5 cm straight wire whip, approximate lengths in that the ideal length depends on materials used to enclose the bare conductors. These lengths are typically prohibitive for practical handheld, wearable, or otherwise portable wireless products.

While specific components of wireless transmitters are discussed above with respect to FIG. 2, one skilled in the art will recognize that any of a variety of components or variations of components may be utilized in accordance with embodiments of the invention as appropriate to a particular application.

### Wireless Receivers

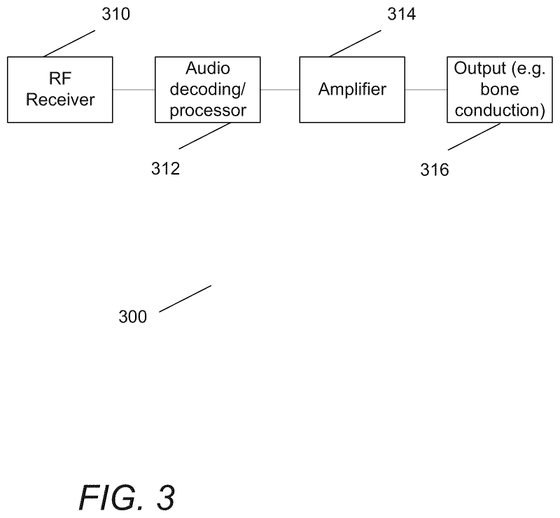

A wireless coaching system receiver in several embodiments of the invention includes receiver circuitry, which may be housed in a headset enclosure. In several embodiments of the invention, the headset enclosure of the receiver is configured to clamp or attach securely to a user's head. Receiver circuitry can include components such as, but not limited to, one or more receive antennas, one or more amplifiers, one or more audio decoders/processors, and/or a battery (such as a lithium polymer battery). In some embodiments, some components, e.g., amplifiers, decoders/processors, and/or battery, can be located on a printed circuit board (PCB). In further embodiments, the PCB can be located centrally along the band of the headset. The PCB being located close to the center of the band can reduce self-interference from wires (e.g., battery wires). Elements of a wireless receiver 300 in accordance with an embodiment of the invention are conceptually illustrated in FIG. 3.

The receive antenna 302 can be used to receive radio frequency signals, such as those transmitted by a transmitter discussed further above. In some embodiments, the receive antenna is integrated or embedded into the inner or outer surface of the headset enclosure. In other embodiments, the receive antenna can include two tapered counterpoise helical antennas on opposing sides of the PCB as will be discussed further below.

The receiver 300 includes a radio frequency (RF) receiver 310 to demodulate a received RF signal before providing it to audio decoder/processor 312 to extract an audio signal from the RF signal. Any of a variety of receiver circuitry for decoding and/or processing a received signal may be utilized in a receiver in accordance with embodiments of the invention, including, but not limited to, components such as an OnSemi AX8052F143 integrated circuit (IC) for processing the received signal and/or interfacing with user controls. The decoded/demodulated signal produces an audio signal. The audio signal can optionally be further be processed by passive circuitry to perform audio frequency response shaping, such as by, but not limited to, an OnSemi SA575. The decoded audio signal can be sent to an amplifier 314 that amplifies the signal enough to power one or more audio output elements 316. Audio output elements 316 can be any kind of speaker that conveys audio to the user, such as, but not limited to, a dynamic driver, planar magnetic, electrostatic, balanced armature, or bone conductor.

In many embodiments of the invention, the receiver headset utilizes bone conduction technology in the audio output elements 316 to directly vibrate the bones in the inner ear, thereby providing underwater audio to the participants. Headsets utilizing bone conduction technology can be preferable in underwater coaching systems as they are more comfortable to the participants and enhance safety as the participants are still able to hear ambient noise when using the underwater coaching system. In several embodiments, the bone conduction elements have an F0 of 300 Hz for better user performance.

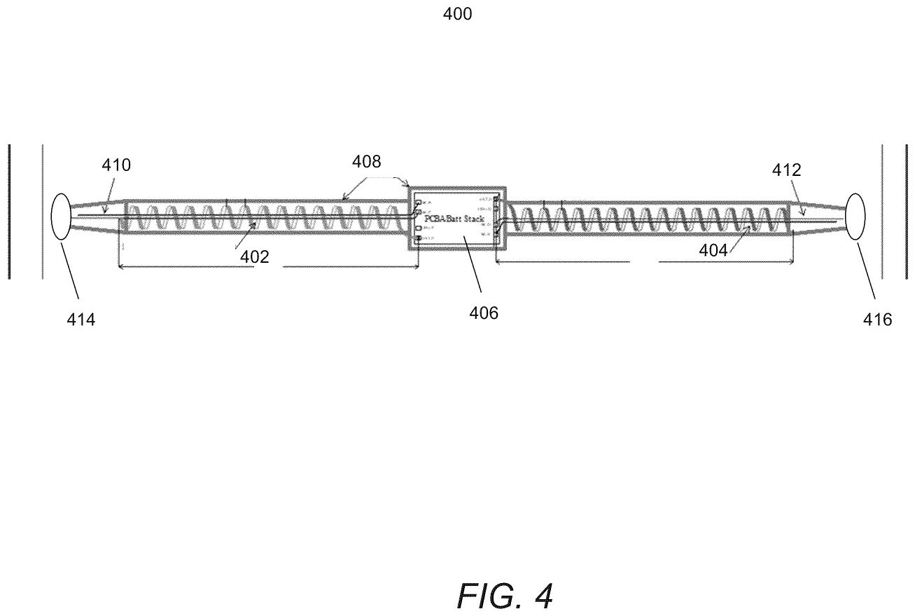

In several embodiments of the invention, bone conductor wires carry a signal from the amplifier 314 to the bone conduction elements 316. In many embodiments, the bone conductor wires pass through the inside the coils of the helical antennas to each side and extend beyond the antennas a certain length as seen in FIG. 4. In some embodiments, a dielectric tube having er=10.2 surrounds the bone conductor wires and centers the wires relative to the helix. In other embodiments, a foam tube surrounds the wires and centers the wires relative to the helix. In further embodiments, no extra layer is used to center the wires within the helix.

Conventional antenna design would indicate that having additional wires (e.g., bone conductor wires) within the perimeter of an antenna (e.g., inside the windings of a helix shaped antenna) or near the outside of the helix shaped antenna would degrade the performance of the antenna. Furthermore, more, thicker, or longer wire in this position should degrade performance further according to conventional knowledge in the field. However, the inventors have found through experimentation that the presence of additional wire of certain dimensions within a helix shaped antenna, while not contacting the antenna, can increase performance or at least does not harm performance of the antenna, if properly designed. Generally, the wire should be positioned within the center 80% cross sectional area of the helix, to avoid as much interaction with the very close reactive nearfield of the antenna conductor and not be in contact with the antenna. In certain embodiments of the invention, given the frequency ranges discussed here, the length of the wire can vary up to 140% (relative to the end-to-end length of the wound helical antenna (i.e., 40% longer) with minor antenna tuning.

Given the inevitable bi-directional electromagnetic coupling of the bone conductor wires to the antenna, extending a certain bone conductor wire length beyond the helix can improve performance (gain) of the helical antenna. Embodiments of the invention can utilize wires that extend 20 mm up to 70 mm past the helix to where it connects to the audio output element 316 without significant effect to the antenna performance.

A receiver can also include one or more switchable input devices, such as those described above with respect to a wireless transmitter. While specific components of headset wireless receivers are discussed above with respect to FIGS. 3 and 4, one skilled in the art will recognize that any of a variety of components or variations of components may be utilized in accordance with embodiments of the invention as appropriate to a particular application. For example, receiver circuitry may be housed together with audio output elements in a headset enclosure, or may be housed separately from audio output elements and provide the audio signal by wire or wirelessly to the audio output elements.

### Receive Antenna

As mentioned above, many embodiments of the invention can include one or more helical antennas. In some embodiments a receiver headset includes two helical antenna elements, one as radiator (poise) and one as counterpoise, together forming a dipole antenna. In additional embodiments, the helical antennas are tapered from one end to the other end, i.e., having a changing diameter of coils.

The electrical length of the poise should be ¼ wavelength of wavelength of the desired tuning frequency. The electrical length of the counterpoise should be equal to or greater than ¼ wavelength of the desired tuning frequency. In some embodiments, the poise has an effective length in the range 330-390 mm to correspond with appropriate frequencies of 192-227 MHz. In many embodiments of the invention, the communication from transmitter to receiver utilizes a frequency in the range of 180-210 MHz. In other embodiments, the communication from transmitter to receiver utilizes a frequency in the range of 100-300 MHz.

A wireless receiver (headset) 400 with a receive antenna system in accordance with embodiments inf the invention is illustrated in FIG. 4. In several embodiments, each of two tapered helical antennas (poise 402 and counterpoise 404) extend from a printed circuit board (PCB) 406 centrally located within the receiver headset toward the ends of the headset within a housing 408. The PCB 406 can include an RF receiver circuitry, audio decoding/processor, and/or amplifier. Bone conductor wires (or other types of connectors to audio reproduction hardware such as speakers) 410 and 412 are connected to the PCB and pass through the helical antennas 402 and 404 to bone conductors or other type of audio output elements 414 and 416.

In many embodiments of the invention, each helical antenna element is 105 mm in length. In several embodiments, the helix of the antennas are uniform 8 mm diameter. In some embodiments, the helix is tapered where the coil at the base is 10 mm outer diameter and 6 mm outer diameter and the opposite end. In a number of embodiments, there are 21 turns of the antenna, which can be reduced to 20.5 or 19.5 turns when connected to ground or to a radio output.

The helical antennas may be one right-hand would and one left-hand wound, both right-hand would, or both left-hand wound.

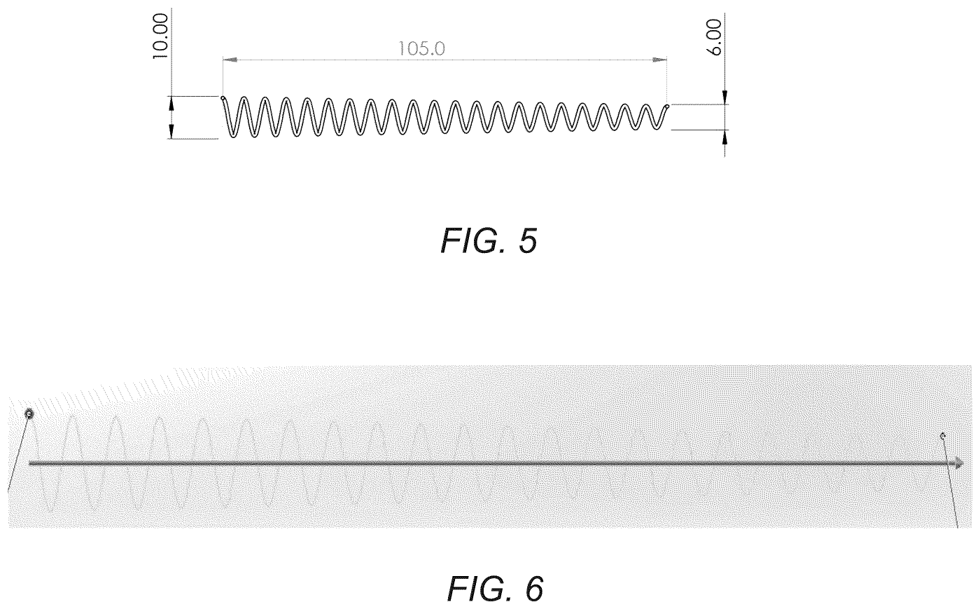

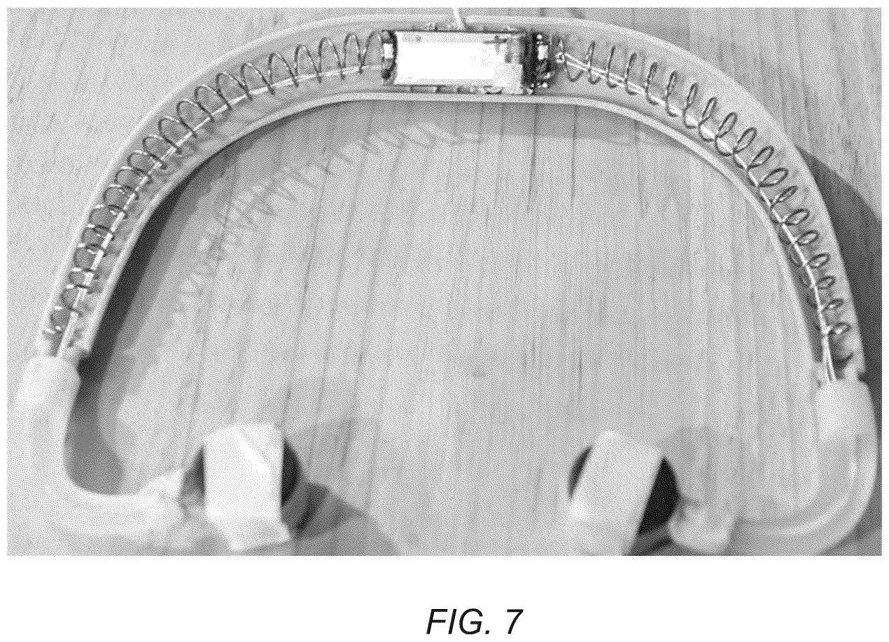

FIGS. 5, 6, and 7 illustrate tapered helical antennas in accordance with additional embodiments of the invention. While certain dimensions are discussed above, helical antennas in accordance with embodiments of the invention may have different dimensions as appropriate to particular application. For example, the effective length should be appropriate to the desired tuning frequency.

Although the present invention has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present invention can be practiced otherwise than specifically described without departing from the scope and spirit of the present invention. Thus, embodiments of the present invention should be considered in all respects as illustrative and not restrictive. It will be evident to the person skilled in the art to freely combine several or all of the embodiments discussed here as deemed suitable for a specific application of the invention. Throughout this disclosure, terms like “advantageous”, “exemplary” or “preferred” indicate elements or dimensions which are particularly suitable (but not essential) to the invention or an embodiment thereof, and may be modified wherever deemed suitable by the skilled person, except where expressly required.

What is claimed is:

1. A wireless audio receiver device comprising:
a first helical (helix wound) receive antenna and a second helical receive antenna;
a printed circuit board (PCB) comprising receiver circuitry coupled to the first helical receive antenna and the second helical receive antenna;
a first audio driver and a second audio driver;
a first audio lead wire connected to the PCB and to the first audio driver and passing through the windings of the first helical antenna;
a second audio lead wire connected to the PCB and to the second audio driver and passing through the windings of the second helical antenna.

2. The wireless audio device of claim 1, where the first helical antenna and the second helical antenna are attached to and on opposing sides of the PCB.

3. The wireless audio device of claim 1, where the first helical antenna and the second helical antenna are each tapered in diameter of the helix.

4. The wireless audio device of claim 3, where the helix of the antenna is tapered where the coil at its base is 10 mm outer diameter and the coil at its opposite end is 6 mm outer diameter.

5. The wireless audio device of claim 1, where the first helical antenna and the second helical antenna coils are uniform 8 mm diameter.

6. The wireless audio device of claim 1, further comprising a battery attached to the PCB.

7. The wireless audio device of claim 1, further comprising insulating material between the first audio lead wire and the first helical antenna and between the second audio lead wire and the second helical antenna.

8. The wireless audio device of claim 7, wherein the insulating material is a dielectric tube.

9. The wireless audio device of claim 7, wherein the insulating material is a foam tube.

10. The wireless audio device of claim 1, where the first audio lead wire is positioned within 80% cross sectional area of the helix of the first helical antenna, and the second audio lead wire is positioned within 80% cross sectional area of the helix of the second helical antenna.

11. The wireless audio device of claim 1, where the first audio driver and the second audio driver are bone conductor speakers.

12. The wireless audio device of claim 1, where the bone conductor speakers have an F0 of 300 Hz.

13. The wireless audio device of claim 1, wherein the PCB contains an audio processor configured to extract an audio signal within a wireless signal received by the first helical antenna and the second helical antenna.
